(19) United States
(12) Patent Application Publication
(10) Pub. No.: US 2020/0250892 A1
(43) Pub. Date: Aug. 6, 2020

(54) Generation of Improved Clothing Models

(71) Applicant: Measur3d, LLC, Tolland, CT (US)

(72) Inventors: James F. O'Brien, El Cerrito, CA (US); David T. Jackson, Redwood City, CA (US); Edilson de Aguiar, San Francisco, CA (US); James L. Andrews, San Francisco, CA (US); Carlo Camporesi, Alameda, CA (US); Scott M. Frankel, Berkeley, CA (US); Zoran Kacic-Alesic, Novato, CA (US); David Macy, San Francisco, CA (US); Nathan Mitchell, Richmond, CA (US); Tobias Pfaff, Oakland, CA (US); Daniel Ram, Sunnyvale, CA (US); Kevin Armin Samii, Berkeley, CA (US)

(21) Appl. No.: 16/411,125

(22) Filed: May 13, 2019

Related U.S. Application Data
(63) Continuation-in-part of application No. 15/232,783, filed on Aug. 9, 2016.
(60) Provisional application No. 62/203,381, filed on Aug. 10, 2015.
(60) Provisional application No. 62/670,402, filed on May 11, 2018.

(51) Int. Cl. G06T 19/20; G06T 13/40; G06T 17/10; G06F 17/50; G06Q 30/06

(52) U.S. Cl. CPC G06T 19/20; G06T 13/40; G06F 2217/32; G06F 17/5009; G06Q 30/0627; G06T 17/10

(57) ABSTRACT

The present invention relates to building a computer model of a garment based on a physical sample garment, and to the process of using the computer model of a garment to determine the garment's appearance on a human body.

### RELATED APPLICATIONS

The present application claims priority to U.S. Provisional Application No. 62/670,402, filed on May 11, 2018. The present application is a continuation-in-part of U.S. patent application Ser. No. 15/232,783, filed on Aug. 9, 2016, which claims priority to U.S. Provisional Application No. 62/203,381, filed on Aug. 10, 2015. All of these applications are incorporated herein by reference in their entirety.

### FIELD

The present invention relates to building a computer model of a garment based on a physical sample garment or based on garment pattern, and to the process of using the computer model of a garment to determine the garment's appearance on a human body.

### BACKGROUND

Purchasers of clothing generally want to make sure that the item will fit, will be flattering, and will suit them well. Traditionally, the person would go to a store, try on clothing, and see if the clothing worked on his or her body, and moved properly. However, more and more commerce is moving online, and people are shopping for clothes online as well. While a photo of the clothing on a mannequin or human model can show what the clothing looks like on the mannequin or model's body, it does not generally provide enough information for a shopper to see how that item of clothing would lay on his or her own specific body, or how the clothing would move as he or she wears it.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is a network diagram of one embodiment of the various systems that may interact in the present invention.

FIGS. 2A-C are a block diagram of one embodiment of the system.

FIG. 3A is an overview flowchart of one embodiment of fitting an item of clothing onto a body model.

FIG. 3B is an overview flowchart of one embodiment of improving the modeling.

FIG. 4 is a flowchart of one embodiment of utilizing geometric macros.

FIG. 5 is a flowchart of one embodiment of mapping embellishments onto garments.

FIG. 6 is a flowchart of one embodiment of up-sampling or down-sampling a simulation mesh.

FIG. 7 is a flowchart of one embodiment of adjusting body models.

FIG. 8 is a flowchart of one embodiment of pose adjustment for body models.

FIG. 9 is a flowchart of one embodiment of symmetry enforcement.

FIG. 10A is a flowchart of one embodiment of pinch handling.

FIG. 10B illustrates some pinch handling options.

FIG. 11 is a flowchart of one embodiment of handling deformability.

FIG. 12 is a flowchart of one embodiment of using barrier shape-based styling.

FIG. 13 illustrates exemplary barrier shapes that may be used.

FIG. 14 is a flowchart of one embodiment of constraint adjustment based on soft constraints and scripting.

FIG. 15 is a flowchart of one embodiment of accounting for plastic warping of materials.

FIG. 16 is a block diagram of one embodiment of a computer system that may be used with the present invention.

### DETAILED DESCRIPTION

The present application relates to improving a computer model of a garment displayed on a body model designed to match a particular person or represent a typical member of a group of persons. The resulting display may include rendered images or video that depict the garment on the body model. The generation of the body model may, in one embodiment, include generating bodies that have no distinguishing features but are brand-appropriate. The model may have articulation, and permit pose adjustment for a variety of reasons including to account for different body shapes. The clothing model may include embellishments which are attached to the clothing mesh to account for details, such as buttons, stitching, or rivets, that are not typically represented by the clothing mesh. In one embodiment, up-sampling and down-sampling the resolution of the whole mesh, or selectively of parts of the mesh, may be utilized. In one embodiment, the modeling may account for plastic warping of the fabrics, through shrinking or stretching. In one embodiment, placing the clothing on the body model may include enforcing approximate symmetry between sides, and/or using barriers to block or guide movement of the cloth and simulate desired positioning of the garment. In one embodiment, this may be done through the use of constraints. Other aspects of this implementation may also be part of the display.

The following detailed description of embodiments of the invention makes reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional and other changes may be made without departing from the scope of the present invention. The following detailed description is, therefore, not to be taken in a limiting sense, and the scope of the present invention is defined only by the appended claims.

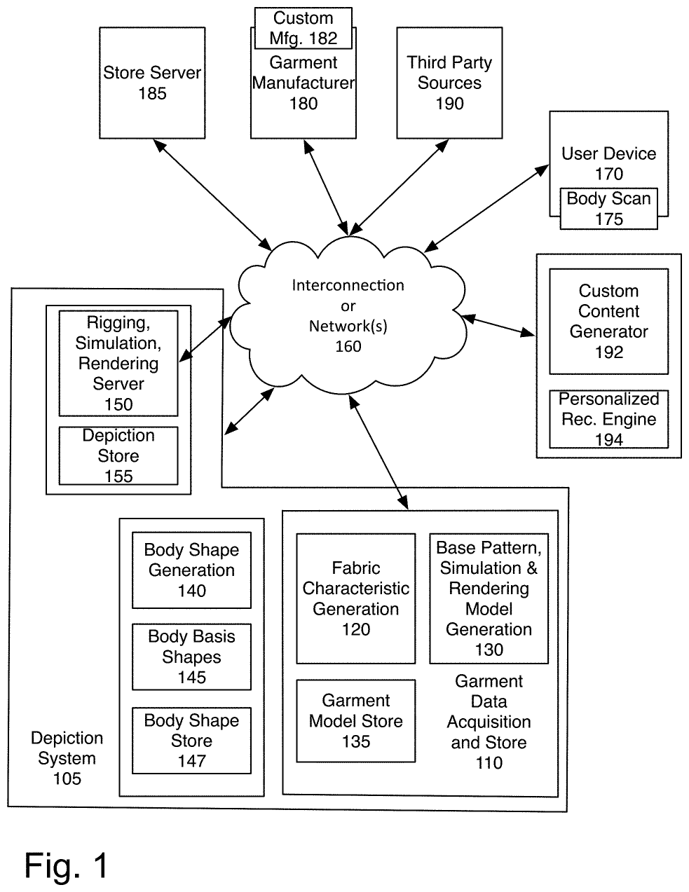

FIG. 1 is a network diagram of one embodiment of the various systems that may interact in the present invention. In one embodiment, a garment data acquisition and store system 110 is provided. This system is designed to obtain simulation models of garments from physical samples. This may be done destructively or non-destructively. In one embodiment, data may be received from garment manufacturer 180 and used, alone or in conjunction with analyzed data to create simulation models of garments. Simulation models of garments stored in store 135 include data on the pattern, fabric characteristics, and how to position the garment on a user. Fabric characteristic generation 120 may obtain the data from the manufacturer 180, other parties 190, or may test the fabric and generate fabric characteristic data locally. Fabric characteristic data includes fabric visual characteristics (appearance), and fabric mechanical characteristics (simulation data).

In one embodiment, body shape generation 140 generates a plurality of body shapes corresponding to one or more buckets of “body configurations.” This includes proportions such as the relative sizes of waist, hips, bust, as well as height, arm length and other aspects of the body. In one embodiment, each person's data is compared to a set of body basis shapes and the body shape for each person is created from a combination of the body basis shapes. In one embodiment, a large but limited number of predetermined body shapes is available, and each user is matched to the closest body shape. In one embodiment, body shape generation 140 also alters the surface aspects of the body shape, such as skin tone, hair length and color, etc. This enables a user to view an item of clothing on a body shape that looks like him or her.

The rigging, simulation, and rendering server 150 takes the garment model, and the body shape, and creates a depiction, which shows how the garment would appear and move in the real world. In one embodiment, the rigging places the garment on the body shape, the simulation calculates the lighting interactions and stretch and the impact on the garment of being worn, while rendering generates the output of a depiction, which may be an image, a video, or other output showing the garment's functioning on the body, stored in depiction store 155. Such a depiction is substantially different than traditional generated images of a garment on a model, or simulated “fitting” images in which a cut-out garment is represented, without showing the real impact of the curvature around the body, lighting, and movement on the appearance and movement of a garment.

In one embodiment, depictions may be made available to store servers 170, or otherwise made available to users on user devices 170. The user devices 170 may be a mobile device, such as a cell phone, tablet computer, game console, laptop, or other computing device. The store server 185 in one embodiment, further includes a mechanism to enable matching of representations, which enables a matching of garments that would fit similarly. This type of automatically generated match-by-fit would be calculated based how a garment moves and appears around the body, and does not exist in current commercial offerings. Current recommendations or searches make use of information about a user's preferences, past history, or other factors. However, without information about the user's body shape, such recommendations and search results are often wrong. For example, two people with very similar preferences, style, and other characteristics may purchase very different clothing if one is tall and heavy and the other is short and thin.

In one embodiment, the combination of the body shape data, from body shape store 147, and the garment data from garment data acquisition and store 110 may be used by garment manufacturers 180, to optimize garment design, based on cumulative data. In one embodiment, the body shape store data 147 may be used in custom manufacturing 182, to create customized garments for a user. This enables a manufacturer, for example, to produce garments which are customized based on the user's personal information. In one embodiment, the custom manufacturing 182 may be automated, based on the garment data store 110 and the body shape data from body shape store 147.

The personalized recommendation engine 194 in one embodiment uses information that could include one or more of: body shape, user history, matches to users with similar body shapes and/or user histories, matches to users with similar search and/or purchase history, explicit preferences, and other information. In one embodiment, custom content creator 192 can create personalized look books, which display a series of clothing items, selected for the user, on a body shape matched to the user. Custom content creator 192 may also create other customized content, including advertising content customized for the user, based on the user's body shape data.

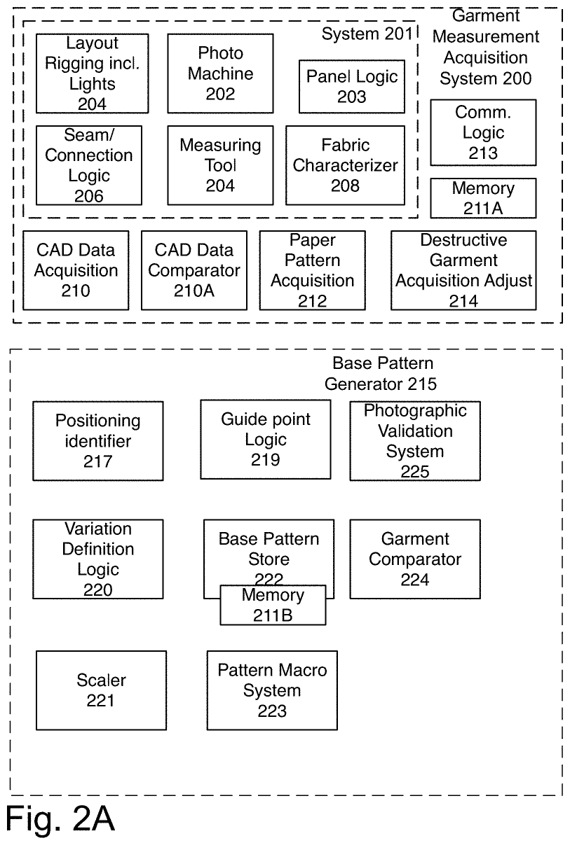

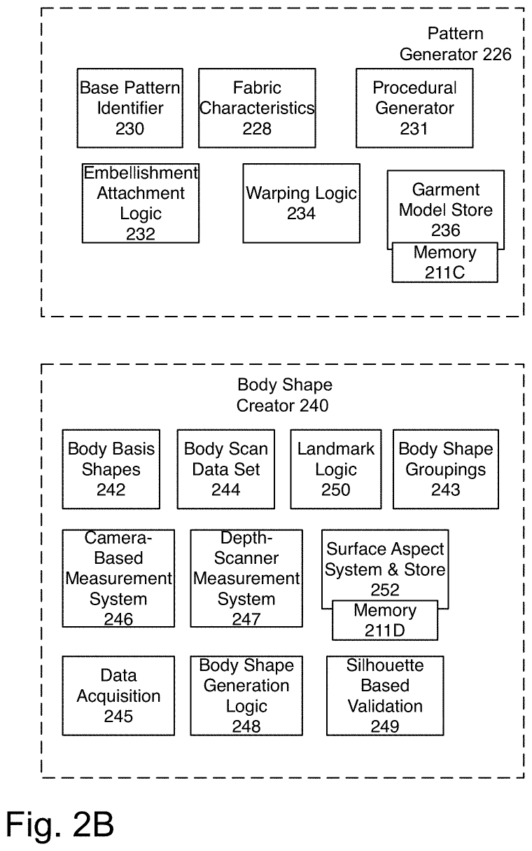

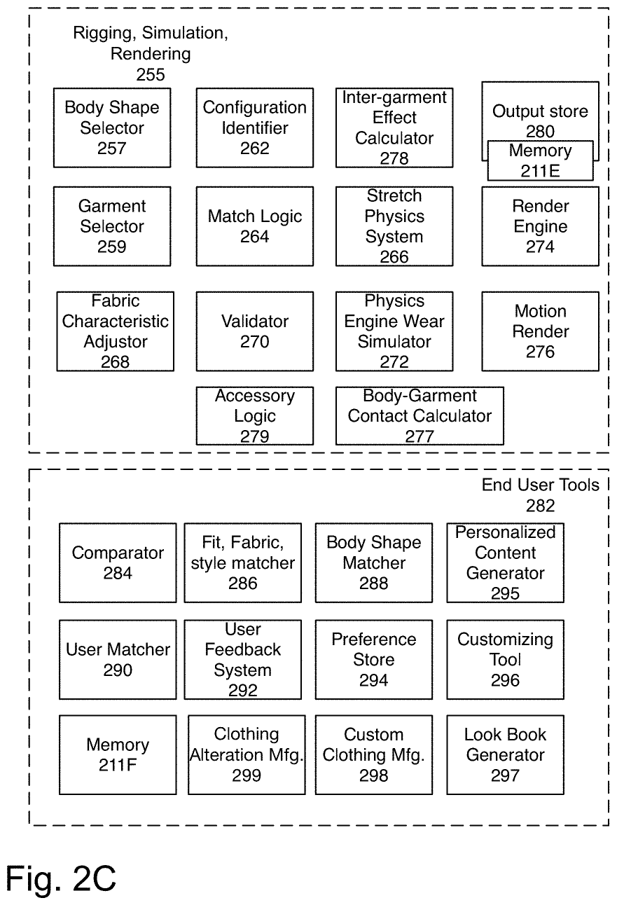

FIGS. 2A-C are a block diagram of one embodiment of the system.

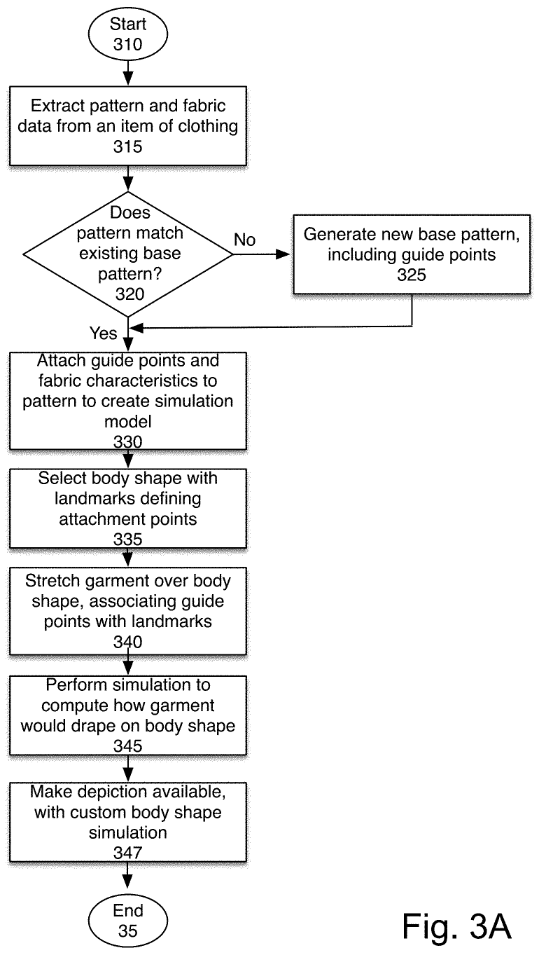

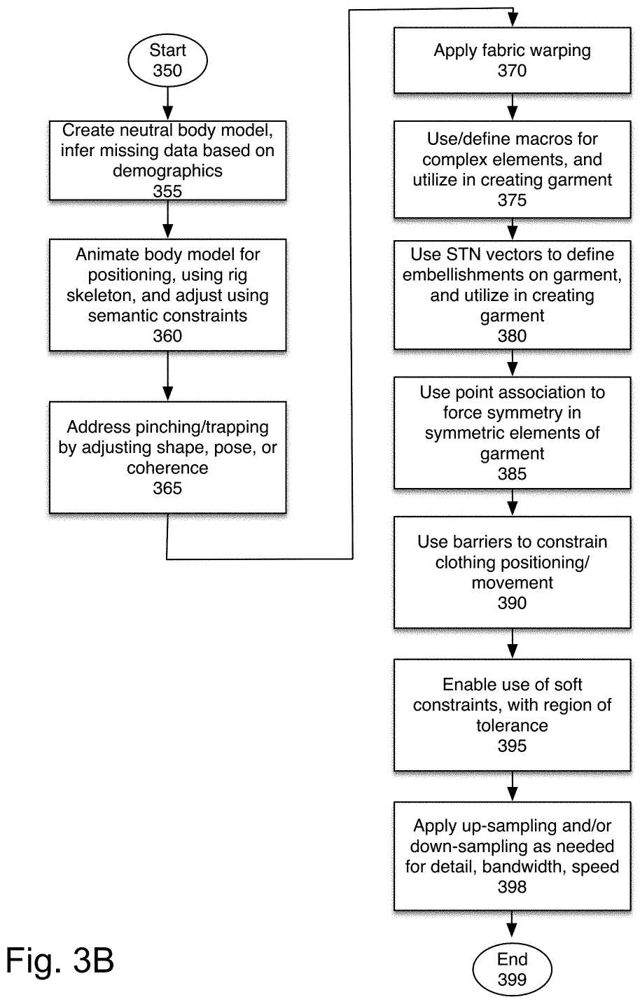

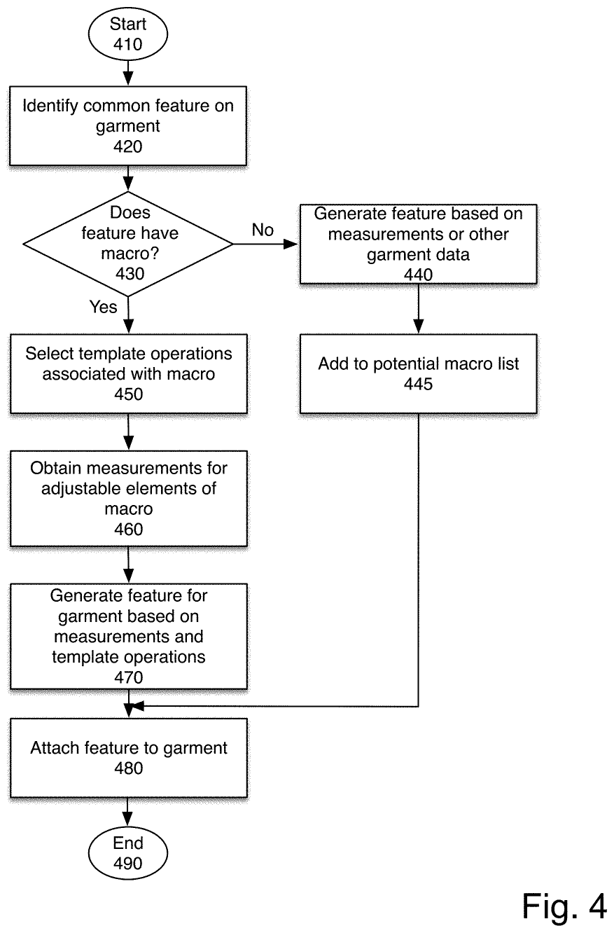

FIG. 3A is an overview flowchart of one embodiment of the system creating and depicting of one or more items of clothing on a body shape. The process starts at block 310. At block 315, the pattern and fabric data are obtained for a garment. FIG. 4 describes one method of data extraction.

At block 320, the process determines whether the extracted pattern data matches an existing base pattern. A base pattern is defined by panels and connections, and the relative sizes and attachments of those elements, in one embodiment. If the newly analyzed garment does not match a base pattern, at block 325 a new base pattern is created. A base pattern defines a pattern that is used as a basis for the actual simulation models. The base pattern has associated with it one or more guide points. The guide points define the positioning of the pattern on the body shape (simulating the placement on an actual user.) The process then continues to block 330.

At block 330, the guide points from the base pattern are added to the clothing model. The fabric characteristics and embellishment data are also added. This creates a complete clothing model, including a rendering model and a simulation model.

At block 335, the system selects the appropriate one of multiple body shapes, based on the measurement data for the user. In one embodiment, the selection is based on the user's body scan, and designed to look similar to the user. The body shape includes landmarks defining attachment points, where garments are positioned on the body shape. A particular body shape is selected to create the representation. In one embodiment, the body shape is selected in response to user data, the body shape selected to match the user. In one embodiment, the system pre-creates the depictions, so when a user requests a particular garment, the appropriate depiction on a body shape matching the user's body is retrieved from a set of stored depictions. In one embodiment, if no pre-created depiction is appropriate to the user's body then a new depiction is created and displayed to the user.

In one embodiment, the new depiction is added to the set of stored depictions available to other users, making it an extension to the existing set of stored depictions. The extension may be a new depiction based exactly on the user's data, or the extension may be a depiction that is determined such that it is appropriate to the user's data and also extends the coverage of the set of stored depictions in a way that makes it more likely that any future additional users would have an appropriate depiction in the extended set of pre-created depictions.

At block 340, the garment model is stretched over the body shape, and the guide points in the simulation model of the garment are aligned with the landmarks of the body shape. In one embodiment, a garment may have multiple potential positions, and a particular position is selected for the depiction. For example, a user may wear a skirt high or low, and the body shape may include landmarks for both potential positions. The system relaxes the stretch, until the garment simulation model is in position on the body shape.

At block 345, the system performs the simulation to compute how the garment would drape on the body shape, and renders the representation of the garment model on the body shape. The simulation uses a combination of the simulation model which includes the fabric mechanical characteristics and the rendering model which includes the fabric visual characteristics. The simulation and rendering may generate still images or video, or geometric models with lighting and other visual attributes stored as precomputed textures. In one embodiment, the output of the simulation and rendering may be photo-realistic images and/or video. In one embodiment, rendering may also create stylized depictions of the garment. In one embodiment, the rendering may also create visualizations that convey information that would not otherwise be visible, for example tightness of fit warmth, or other information that would be useful to a user of the system.

The output depiction data is then stored, in one embodiment. At block 347, the garment model is made available, with a customized body shape, so that user can see how a particular garment would lay, move, and appear on themselves. In one embodiment, the data is generated on-the-fly and displayed to the user immediately. The process then ends at block 349.

Of course, though FIG. 3A, and subsequent figures, utilize a flowchart format, it should be understood that the processes described may vary from the process illustrated, and that the specific ordering of the blocks is often arbitrary. For example, the fabric analysis may be done entirely separately from the clothing analysis, or in parallel with the clothing analysis. Similarly, the generation of the various simulations and data sets may be done in parallel, or in any arbitrary order. For example, the generation of the body shapes and the generation of the garment models are substantially independent, and may be performed in any order, and at any time distance from each other.

Therefore, for this flowchart and the other flowcharts in this application it should not be assumed that just because block A follows block B, the process necessarily must flow in that directly. Only when the dependency is made clear should the ordering of the blocks be considered definitive. Furthermore, while processing is described as a flowchart, the steps may be driven by external constraints, not shown. For example, the rendering may only be done upon request, when the garment is made available for purchase, or when a user requests a particular garment. The flowcharts below similarly should not be interpreted to constrain the relationship between the process blocks, unless necessitated by interdependencies.

FIG. 3B is a flowchart of one embodiment of improving the modeling. The process starts at block 350. In one embodiment, at block 355 a neutral body model is created. The neutral body model typically does not include personal features but reflects a user's body shape and size. In one embodiment, if data is missing during the body model creation, demographic data may be used to fill in those missing elements. The demographic data may be based on the type of store or garment, user characteristics, location, or other data.

At block 360 the body model is animated for positioning, using a rig skeleton to ensure that the positioning is accurate.

At block 365, the system addresses pinching/trapping by adjusting the shape of the body model, the pose of the body model, or the compliance of the body model. This is designed to ensure that the garment, once positioned on the body will not show trapping and/or pinching.

At block 370, fabric warping is applied to the garment model, to account for any effects of pre-washing or pre-distressing, which can alter the shape and/or characteristics of the fabric.

At block 375, macros are used, or defined, to represent complex elements. For example, pleats, or cuffs may be defined as macros and used with customization rather than defined from original principles each time.

At block 380, three dimensional vectors are used to define embellishments, which are attached to the garment. This is a special case of the macros, in which the element is three dimensional (e.g. a decorative button).

At block 385, point association is used to force symmetry for symmetric elements of the garment. In one embodiment, the symmetry may be perfect (e.g. elements much match perfect across the line of symmetry) or imperfect, e.g., more flexible or sloppy, where small deviations from the symmetry are expected, if not preferred. In one embodiment, the term symmetry as used herein encompasses both perfect symmetry or imperfect symmetry. Additionally, symmetry is across the user's body symmetry, so if the stance of the body model is not even, approximate symmetry encompasses the symmetry adjusted for such a body stance. This will be discussed below in more detail.

At block 390, barriers are used to constrain the clothing positioning and movement. This enables the system to represent a sweater with the cuffs pushed up, or an open blazer. In one embodiment, at block 395, soft constraints are applied to barriers, symmetry elements or other constraints to the fabric. Soft constraints are more flexible and permit the fabric to move more naturally.

At block 398, up-sampling and/or down-sampling is applied to the final modeled garment, to accommodate additional detail (up-sampling) or lower bandwidth/display quality (down-sampling.) In one embodiment, the up-sampling and/or down-sampling is accomplished using physics-based optimization. The up- and down-sampling may be done in an adaptive fashion where the adaptivity is controlled by geometric detail, viewing perspective, or other criteria. The process then ends at block 399.

FIG. 4 is a flowchart of one embodiment of utilizing geometric macros. In one embodiment, this process is utilized during the garment acquisition. The process starts at block 410. In one embodiment, this process is invoked when a common feature is identified on a garment, at block 420. Instead of requiring that the acquired garment possess the full geometric detail for commonly occurring features, these features may be generated automatically from a template set of operations. For example, a cuff could be added to a plain sleeve by specifying the length of the cuff that should be appended to the sleeve and the macro adds the extra, stiffer material, buttons, and the folds in the material that form the shape of a cuff.

In one embodiment, the identification may be automatic based on matching the feature to the observed position, size, and configuration that are typical of or indicative to that type of feature. In one embodiment, this may mean that a feature which is outside or unusually configured may not be automatically identified. In one embodiment, the identification may be manual.

As noted above, garment acquisition in one embodiment includes a plurality of high definition images, and measurements. Geometric macros enable placing features that are common on a garment which may be placed using a pre-defined and adjusted macro. For example, such common features may include pockets, collars, cuffs, plackets, etc. In one embodiment, such features are elements which are attached to a panel of the garment but are not themselves a garment panel. In one embodiment, such features are restricted to elements which are relatively complex to generate but have consistent configurations across garments. In one embodiment, there may be separate macros for similar features that are differently configured. For example, a men's oxford collar is generally similarly configured to all other dress shirt collars, but differently configures than a woman's blouse collar. Thus, a “collar” may have a plurality of different macros depending on its specific features.

At block 430, the process determines whether the identified feature has a macro. If no macro exists, at block 440, the feature is generated based on the measurements and other garment data, as described above. In one embodiment, at block 445, the feature is added to the potential macro list. In one embodiment, if the same feature is identified in a significant number of garments, the system may trigger a recommendation to create a macro for the feature. Utilizing such a macro saves time and produces more standardized results, compared to generating the garment feature based on measurements and other garment data. The process then continues to block 480.

If at block 430 the system determined that the feature does have a macro, the process continues to block 450.

At block 450, the template operations associated with the macro are selected. The template operations define the operations which are used to generate the feature. That is, they define the shapes and other data associated with the feature.

At block 460, the measurements are obtained for the adjustable elements of the macro. The adjustments may be made for size, configuration, and positioning of the macro. For example, for a collar, the template operations may include the size and shape of the collar, as well as the presence and absence of buttons, etc. For a pocket, the template operations may include the size and positioning of the pocket.

At block 470, the feature is generated for the garment, based on the measurements and the template operations.

At block 480, the feature is attached to the garment. The process then ends at block 490. By using macros to define complex features on a garment, the process of generating the garment template is speeded up.

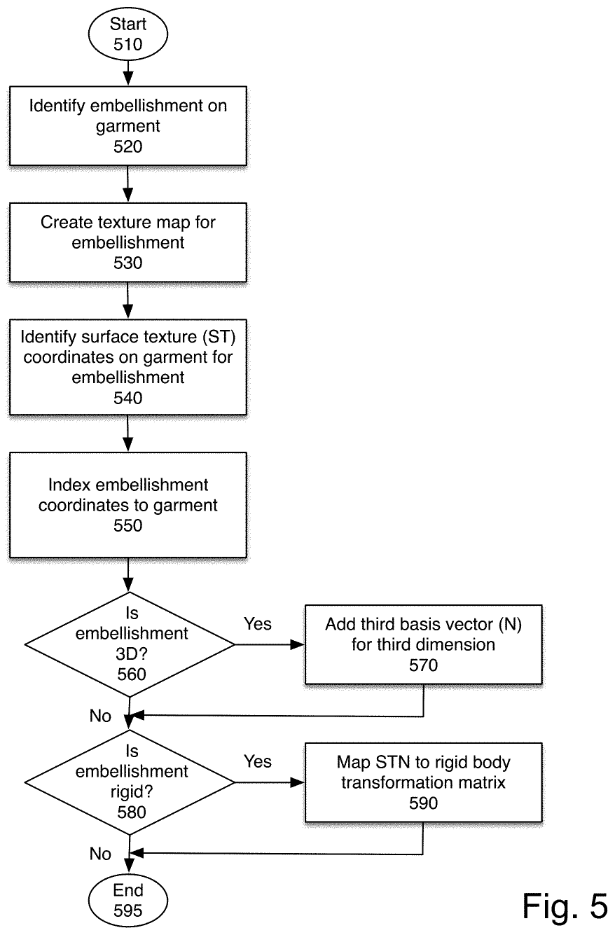

FIG. 5 is a flowchart of one embodiment of mapping embellishments onto garments. The process starts at block 510. In one embodiment, this process is invoked when at block 520 an embellishment is identified on a garment. This is done so geometric detail can be added to the clothing model in such a way that is moves with the simulation, even though the detail may not be specifically modeled in the simulation.

At block 530, a texture map is created for the embellishment. Texture mapping is a method for defining high frequency detail, surface texture, or color information for the computer-generated representation of the garment.

At block 540, the surface texture (ST) coordinates are identified for the embellishment. A simple example is that a decal can be applied as a texture map to the garment using a standard set of “S and T” surface texture coordinates. Each point on the garment is assigned a pair of numbers forming an S and T coordinate at that point. The ST values are then used to index into the texture map so that the texture appears as if it were a decal applied to the surface and that moves with the surface.

At block 550, the embellishment is indexed to the garment. That is, the embellishment is positioned on the garment, defining its position. In one embodiment, for some embellishments, the position may be variable.

At block 560, the process determines whether the embellishment is three dimensional. Three dimensional embellishments extend from the garment, and thus they have height/depth and they appear to be volumetric objects. They may also have separate appearance characteristics associated with movement. If the embellishment is 3D, at block 570 a third basis vector (N) is added to represent the third dimension, to the two vectors (ST). The process then continues to block 580. In one embodiment, the N coordinate is zero at the surface and grows positive in the outward direction and negative inward. Using this STN coordinate system, a 3D structure, such as a layered pocket, small frills, or raised stitching, can be mapped on to the surface so that it moves with the surface.

At block 580, the process determines whether the embellishment is rigid. A rigid embellishment may be a button for example. Rigid embellishments move differently than non-rigid embellishments. For example, raised stitching will bend and flex with the cloth to which it is attached, but a button will not bend or change its shape. Accordingly, at block 590, the STN coordinate system is mapped to the nearest rigid body transformation matrix, and this matrix is used to transform the detail object so that it appears to move with and be attached to the surface but does not deform even as the underlying garment deforms. The mapping of the STN coordinate system to the nearest rigid body transformation may be done by applying an algorithm such as polar decomposition or singular value decomposition to the transformation matrix built using the vectors of the STN coordinate system. The process then ends at block 595.

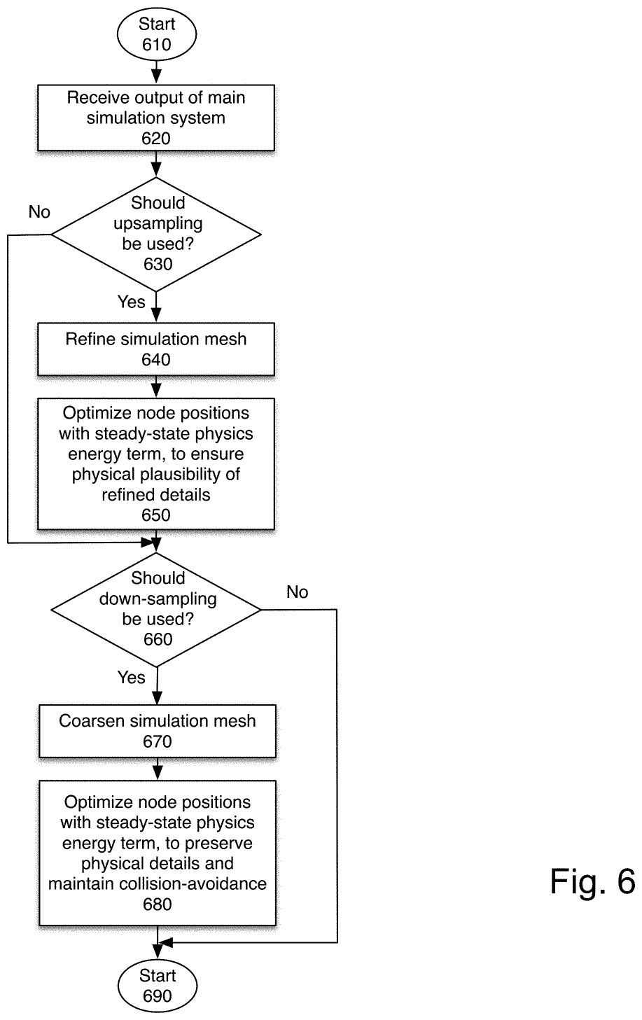

FIG. 6 is a flowchart of one embodiment of adaptively refining and coarsening a simulation mesh. The process starts at block 610. In one embodiment, this process is done after the iteration of the main simulation algorithm. The output of the main simulation system is received at block 620.

In one embodiment, the system determines whether up-sampling is needed for details. In one embodiment, up-sampling is utilized to add extra detail. For example, for a highly textured garment, up-sampling may be useful to provide the realistic appearance. Refining the simulation mesh adds extra detail by up-sampling the simulation mesh to a finer level of detail.

If up-sampling is needed, the simulation mesh is refined, at block 640. In one embodiment, this may be done for a sub-portion of a garment. For example, if a garment has a highly pleaded or embellished area, the up-sampling may be focused on that area.

At block 650, the system runs an optimization over the node positions with a steady-state physics-based energy term. This ensures that the newly refined details are added in a physically plausible fashion. The prior art method of adding detail then smoothing, for example with a Laplacian filter or subdivision, adds detail in a way that does not preserve the physical appearance of fine wrinkles, folds, and other features. The technique described here enables the addition of detail while maintaining the physical appearance of fine wrinkles and folds that make the garment appear realistic. In one embodiment, the process continues to block 660, to determine whether down-sampling is needed. In some instances, portions of a garment may be up-sampled, while other portions of the garment are down-sampled. In another embodiment, the process ends at block 690, after applying the up-sampling to the garment.

If at block 630 the process determined that no up-sampling is needed, the process continues directly to block 660. In situations where a lower resolution mesh is preferred, for example on a mobile device or low-bandwidth network connection, small device, or limited web browser, the system can coarsen the mesh after the simulation has been completed, at block 670. The process then runs an optimization over the node positions with a steady-state physics energy term, at block 680. This produces a simplified mesh that preserves physical details and also remains collision-free. This is a better quality down-sampling than purely geometric approaches that do not preserve physical details and may also produce output that contains collisions. The process then ends at block 690.

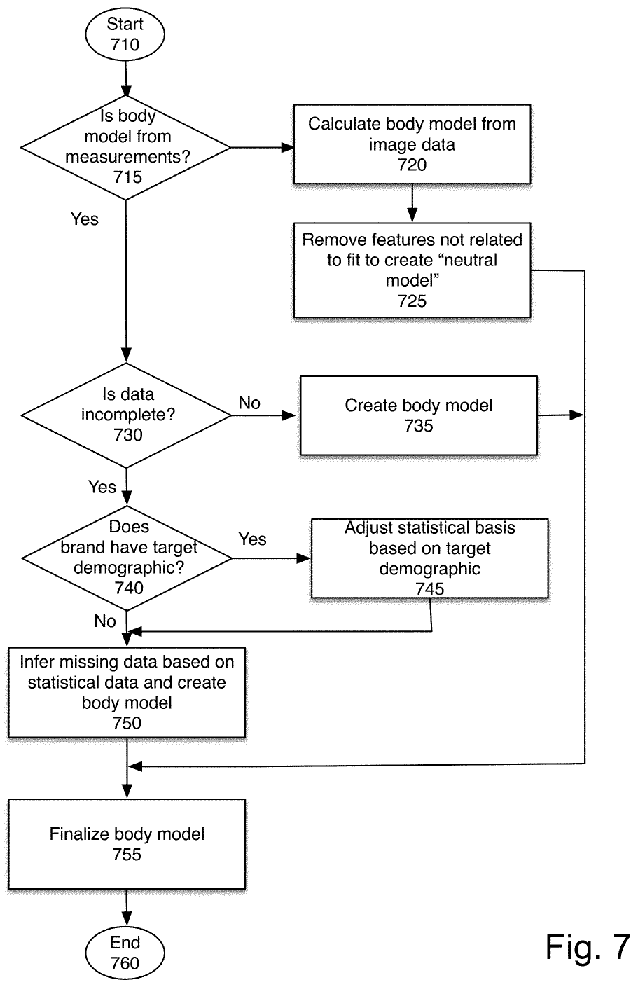

FIG. 7 is a flowchart of one embodiment of adjusting body models. As discussed above, the garments are designed to be placed on a body model which matches the user. Creating appropriate body models for a target demographic provides a better experience for shoppers who have not entered their own personal measurements into the system or have provided an incomplete data set. The process starts at block 710. At block 715, the process determines whether the body model is from measurements. If no measurements are provided, in one embodiment body model data may be obtained from image data. If image data is provided, in one embodiment, the image and measurement data are combined.

At block 720, the system calculates a body model from scan and/or image data. The body model is defined by a plurality of measurements, such as hips, waist, inseam, etc., as well as measurements like arm length and body shape.

At block 725, features that are not related to the fit are removed to create a neutral model. Depictions of a person's body can be a sensitive topic. Even if a depiction is geometrically and physically accurate, a person may still find it offensive or upsetting. For example, a body model may have wrinkles and bumps in the skin removed. This will produce a more generic looking model that still has the correct proportions. The generic model may be perceived as being less personal so that the viewer is less likely to be offended. The same applies to removing facial details, distinctive marks, and other features that allow specific individuals to be identified. In one embodiment, this is accomplished by processing the statistical database of body shapes so that these details are removed. The resulting models constructed by matching input measurements or by matching to a scanned body model will also be free of such details. Alternatively, specific types of features may be explicitly removed from a constructed body. For example, the entire head may be segmented from the rest of the body and removed so that the result appears similar to a headless mannequin.

The process then continues to block 755 to finalize the body model, and end at block 760.

If the body model is built from measurements, at block 715, the process continues to bock 730.

At block 730, the process determines whether the measurement data is incomplete. If the measurement data is complete, at block 735 the body model is created, and the process continues to block 755, to finalize the body model. The body models created only from measurements need not be neutralized in one embodiment. In one embodiment, such body models may also be made more neutral to remove bumps in the skin or other such data that does not impact fit but is personal.

If the data set for measurements is incomplete, as determined at block 730, the process continues to block 740. At block 740, the process determines whether the brand for which the model is being generated has a specific target demographic. If a clothing brand is designed for a certain target demographic, then the database of body information used to generate bodies may be adjusted so that it most accurately conforms to the target demographic. Bodies built from specified measurements would more likely to match a user from the target demographic but less likely to match others outside the demographic. This is applicable especially for incomplete data sets, e.g. having only height and weight but no other measurements or no body shape designation. For example, for competitive sportswear, a 5′4″ 180 pound user may typically be muscular rather than overweight. If the brand has a target demographic, the statistical basis for the inference, at block 750, is adjusted based on the target demographic.

At block 750, the missing data is inferred based on the statistical data to create a body model. The missing measurements may be inferred from the statistical data such that the results maximize the likelihood that the final body would be close to the size and proportions of a user represented by the statistical data.

The process then continues to block 755 to finalize the body model, and end at block 760.

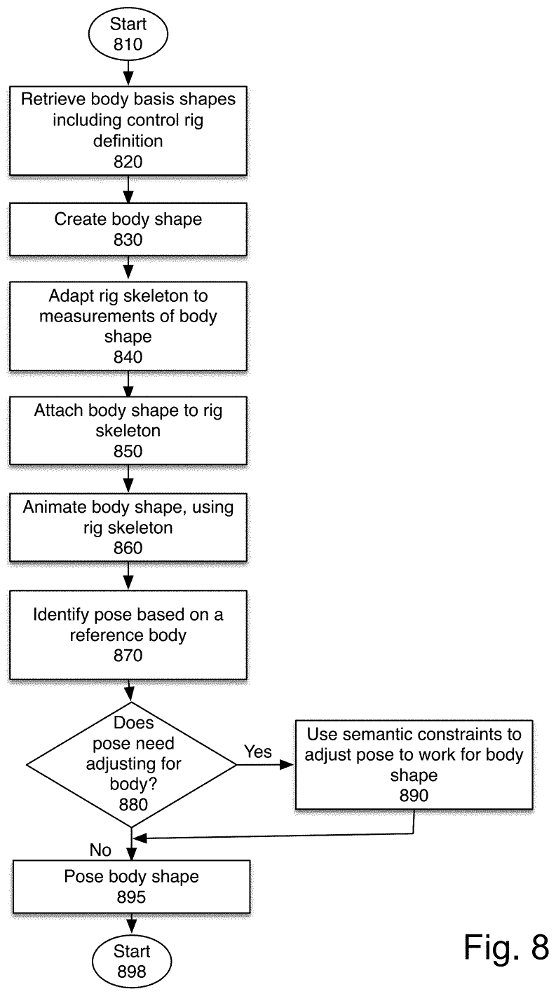

FIG. 8 is a flowchart of one embodiment of pose adjustment for body models. The default pose for a body model is typically arms out to the side (termed “T pose”), or arms at 45 degrees (termed “A pose”). This default pose allows the body to be optimally scanned or viewed, and it also facilitates placing clothing onto the body, but it is unflattering for displaying clothing and generally unsuitable for making aesthetic evaluations related to style or fit. To move the body model so that it is in a more flattering pose utilizes animation controls to move body parts in an anatomically reasonable way. Rigging each body model individually is cumbersome and time consuming so an automated method is used, as described here. The process starts at block 810, in one embodiment when a body pose adjustment is initiated.

At block 820, the body basis shapes are retrieved, including semantic (labeled) information in the body database, labeling each body part with information about how it should attach to a rig skeleton. The rig skeleton is an articulated skeleton that is placed inside or overlaid onto the model and each vertex of the model is then bound with weights to one or more of the skeleton's components, which are often called bones. Other options include using a deformer or other type of control rig. The process of setting up the controls is called skeleton rigging or rigging the body model.

At block 830, the body shape is created from the body basis shapes. Because each body basis shape includes the control rig definition, as the body shape is created, the elements attach in an anatomically reasonable fashion. Thus, when a body is constructed from measurements using the body database the information relating to rig attachment is also transferred to the created body model.

At block 840, the rig skeleton is adapted to the measurements of the body shape. For example, the shoulder width defines the attachment for the arms, and the length of the arm defines the location of the elbow and other joints. The rig skeleton is adapted so that it's bone lengths and other measurements match the generated body.

At block 850, the body shape is attached, or associated with, the adapted rig skeleton.

At block 860, the body shape can then be animated by adjusting the controls of the skeleton. Animation in this context may include positioning the body shape in an anatomically realistic fashion, but in a configuration that is appealing, e.g. closer resembling a model's stance rather than an T pose or A pose used in standard body fitting.

In one embodiment, animation may also include creating a video or other moving image set for example the body model walking down a runway or twirling. As discussed above, the physics of the clothing animation also includes the ability to handle such animation.

At block 870, the process identifies one or more poses for the body shape, to be used. These poses may include model-type poses, walking, etc.

At block 880, the process determines whether the pose should be adjusted for the particular body model. Pose parameters that are correct for one body may not work for another. For example, a pose with the hands on the hips using an average build reference body may be incorrect when applied to a thin or heavy body. With the heavy body the hands may penetrate the hips, with the thin body the hands may not touch the hips. Other changes in the body model may cause a pose to look out of balance or otherwise unrealistic. If any of these problems are identified, at block 880, the process continues to block 890.

At block 890, to correct these problems, a pose is supplemented with semantic constraints, such as keeping the hand touching but not penetrating the hips, or that the center of mass for the entire body should be centered above the feet. The adjustments to the pose parameters can then be computed automatically, in one embodiment using a process called inverse kinematics or another mathematical method for optimization of the semantic constraints.

At block 895 the body shape is then posed, and the process ends at block 898.

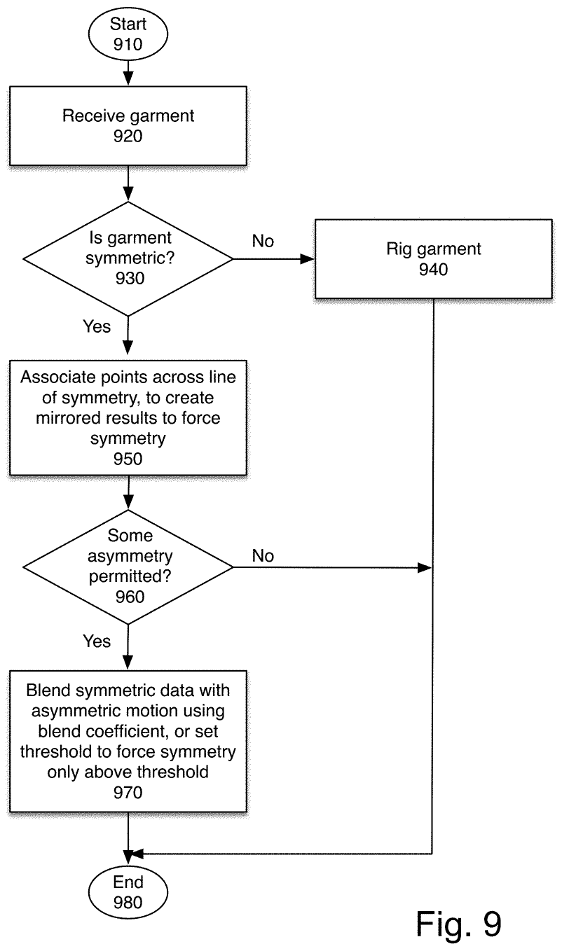

FIG. 9 is a flowchart of one embodiment of approximate symmetry enforcement. For garments that should rest symmetrically on the body, a person wearing the clothing item would typically tug the garment into place. For example, the user would shift an oxford shirt so that the collar is symmetric. In the context of an autonomous simulation, parts of the simulation can be associated with the corresponding part across the symmetry.

The process starts at block 910. In one embodiment, the process is initiated when a garment is received for rigging onto a body model, at block 920.

At block 930, the process determines whether the garment has symmetric components. While many garments have symmetric components across the user's body not all garments do. If the garment does not have symmetric components, at block 940 the garment is rigged in the standard manner. The process then ends at block 980. If only selected portions of the garment should be symmetric then only those portions would be subject to further processing. However, because the symmetric components may be attached to asymmetric portions it is possible that processing of the symmetric portions could cause changes to the asymmetric portions.

If the garment is symmetric, at block 950, vertices or other points are associated with each other across the line of symmetry. For example, the points on the right side of a shirt collar can be associated with their corresponding points on the left side. When the simulation is run, the forces, velocity, and movement of the left side is mirrored about the symmetry and averaged with the right side. The result is then used for the simulation of the right side and the mirrored result is used for the left side. This forces movement of those parts of the garment to be symmetrical while still allowing physically realistic motion and not requiring manual tugging or tweaking.

At block 960, the process determines whether some asymmetry is permitted. If not, the process ends at block 980. If slight asymmetry is permitted then, at block 970, the computed symmetric motion can be blended with the original asymmetric motion using a blend coefficient. Alternatively, a threshold may be maintained, and symmetry only enforces when the asymmetry exceeds the threshold. Another alternative is to create a symmetry plane that is midway between points that should move symmetrically and then constrain the points to keep an equal distance to the plane. Similar constraints can be built to enforce other types of symmetry appropriate to specific garments. The process then ends at block 980.

The above process assumes a symmetric stance of the body model. In one embodiment, if the stance of the body model is asymmetric, a similar process may be used to enforce approximate symmetry matching the stance of the body model. These could be guide points or other designated points. In one embodiment, the enforcement of the symmetry/approximate symmetry is adjusted to take into account an asymmetric body pose. For example, if the shoulders are held at an angle such that the left shoulder is higher than the right, then symmetric points on the yoke of the shirt would be shifted to account for that angle.

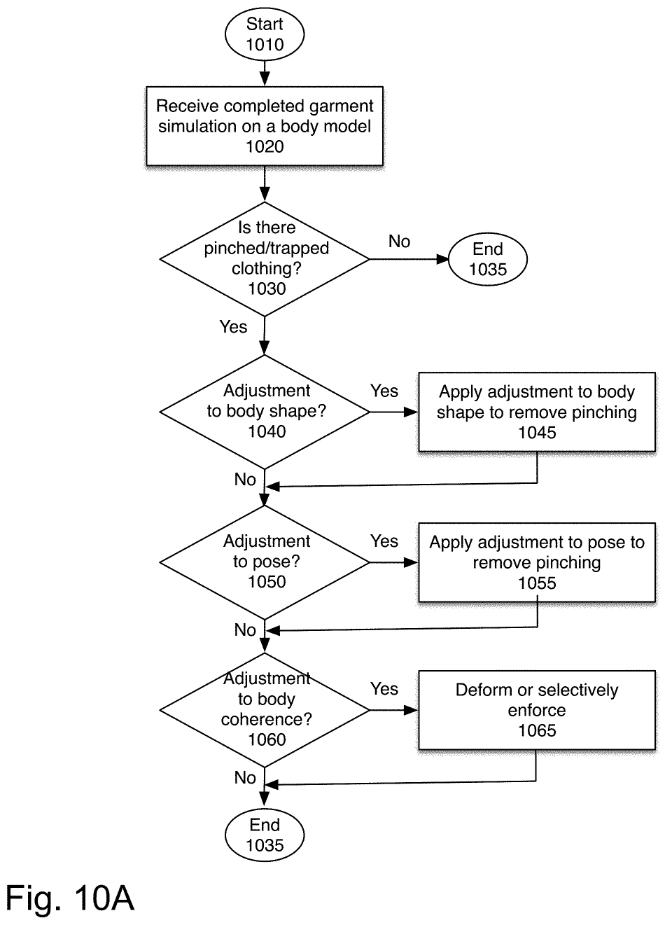

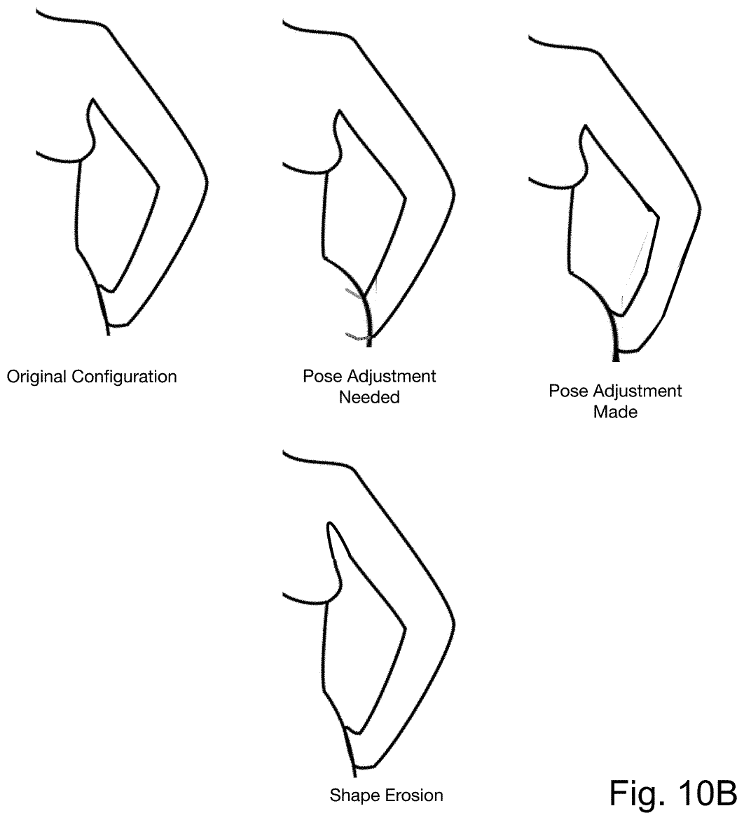

FIG. 10 is a flowchart of one embodiment of pinch handling. The process starts at block 1010. In one embodiment, the process starts after the partially or fully completed garment simulation is received, at block 1020. In one embodiment, the completed garment simulation is stored in memory.

At block 1030, the process determines whether there are any pinched or trapped elements of clothing, in the completed simulation. In cases where it is not feasible or desirable to first determine if a garment is being pinched or trapped, the areas of the body where pinches/traps typically occur may be preemptively assumed to have a pinch, and thus adjusted so as to avoid any potential problems. Typical pinch/trap locations would be identified from observations of previous similar simulations. If there are no such pinched trapped elements or identified typical locations, the process ends at block 1035. If pinched or trapped element or location is identified, the process continues to block 1040.

At block 1040, the process determines whether an adjustment to the body shape should be used to address the pinch/trap. If so, at block 1045, the adjustment is applied to the body shape. The adjustment to the body shape may be erosion. That is, in areas where pinches occur the system erodes the geometry of the human body to create larger gaps that are less likely to cause pinching.

One way to do this adjustment uses signed distance functions. A signed distance function is a function defined on the space in and around a surface, such that the value of the function at a given point is a function of the distance between that point and the closest point on the surface. If the point in space is inside the region of space enclosed by the surface, then the function's value is the negation of the distance to the closest point on the surface. Points on the surface have a value of zero. Approximate signed distance functions may be used in place of a true signed distance function in order to save memory or computation costs.

Collisions and contact between the clothing and the body can be determined using a signed distance function for the body, in one embodiment. Each vertex of the cloth is evaluated in the signed distance function. If the value is negative, then a collision response is applied to the cloth. In one embodiment, a collision response might be moving the cloth vertex in the gradient direction of the signed distance function so that it reaches a location in space where the function is zero.

The signed distance function may be altered in areas where pinching or trapping cloth is a potential problem. For example, the armpit area may pinch cloth between the upper arm and torso. The signed distance function may be adjusted so that cloth that would be trapped in this area is instead treated as if it were not trapped. This will make the portion of the cloth in this area look and move more naturally. Applying modifications to the signed function creates an adjusted body with modified or eroded areas that avoid pinching. This adjusted body is not displayed, it is only used for resolving collisions.

In one embodiment, erosion may be applied prior to the simulation, after identifying areas where pinches/trapping may happen, as a pre-adjustment of the gaps between body elements. In one embodiment, this may be implemented as part of the simulation. In another embodiment, this may be implemented post-simulation, to address detected pinching. In on embodiment, the erosion removes some of the body “thickness” in the pinching areas. This is the imaging equivalent of compressing the body part to create a larger space between the body parts to avoid pinching.

At block 1050, the process determines whether a pose adjustment should be used. If so, the pose is adjusted at block 1055. For a pose of the body that has areas where one part is penetrating another part, the system can compute an adjustment to the pose using inverse kinematics such that the pose is minimally changed but the inter penetration is removed. In one embodiment, instead of utilizing this technique the system may intervene before this causes a problem, as described above in the adjustment of the body shape. In one embodiment, the change to the pose is minimally changed. In one embodiment, two body parts overlap, both are adjusted using inverse kinematics, to eliminate overlap while moving each body part as little as possible. This replaces manual adjustments, and minimizes the distance moved.

At block 1060, the process determines whether body compliance should be adjusted. Body compliance is the combination of the ability of the body to deform, and the collision constraints which maintain the separation between body parts. If so, at block 1065, the body compliance is adjusted.

In one embodiment, this involves applying a function to joints, areas near multiple body parts, or other locations where pinching may occur. In one embodiment, a separate signed distance function (SDF) may be used for each body part. The gradients of the individual SDFs may be combined to give a single collision gradient. If pinching is detected by contact of the same small portion of cloth with multiple body parts, then the collision constraint of some of the body parts will be relaxed to prevent “fighting” between the constraints and avoid pinching. In one embodiment, this allows the penetration of body parts into each other. However, since this is the result of collision, such overlap cannot be seen since it is hidden by the covering body part.

In another embodiment, compliance may be adjusted by simulating the body parts as having the potential for elastic or plastic deformation instead of being rigid. That is, by permitting deformation of the body, in locations where otherwise body parts would intersect or collide or cause pinching. In one embodiment, the system uses a deformable finite element model that computes realistic deformation of human tissue. In another embodiment, a simplified deformation model is used. In one embodiment, the simplified model allows the cloth to go below the surface of the body in pinch regions and then applies a spring-like force that moves the cloth to the surface of the body in a gentle fashion. A signed distance field may be used to compute the spring-like force. Note that although the various adjustments are listed sequentially, the system may apply one or more of these adjustments simultaneously, in parallel, or in any order. In general, only one of these adjustments may be necessary in any one area where pinching or trapping occurs. However, a single item of clothing being simulated may have multiple areas of pinching, and different techniques may be utilized for each such area. In one embodiment, the appropriate technique is selected based on a determination of which technique has the lowest cost in processing/reprocessing, and thus fastest completion. The processing cost would depend on the geometry of the body model, the geometry of the garment model, and the specifics of how the garment is worn on the body. Selection may also be made based on what is expected to produce the most aesthetically pleasing result. This determination may be done manually or automatically based on an existing data set.

FIG. 10B illustrates some pinch handling options.

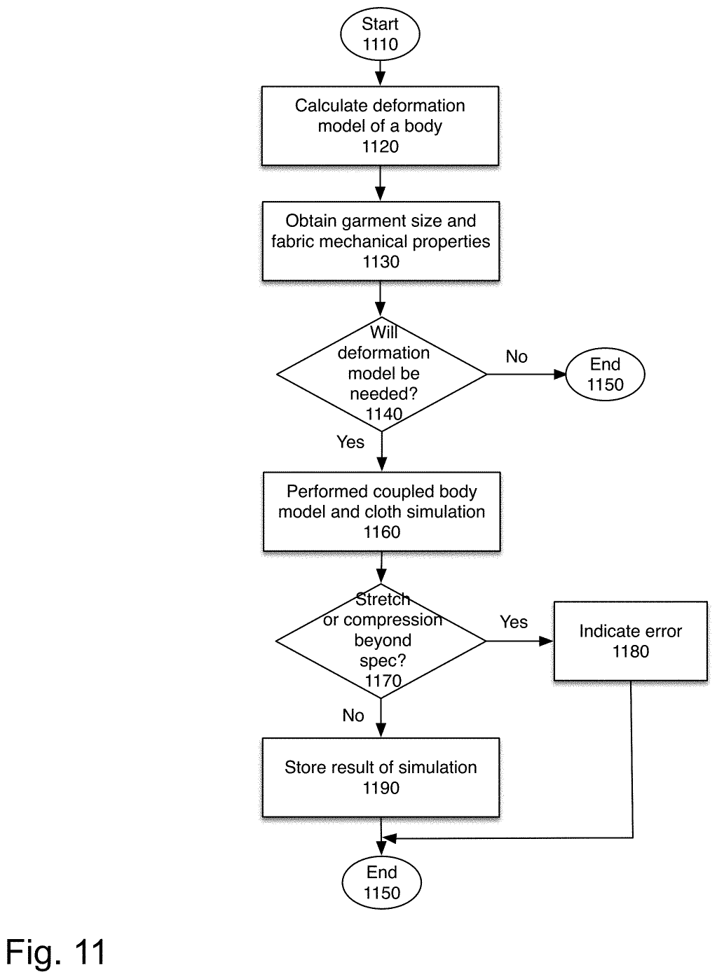

FIG. 11 is a flowchart of one embodiment of deformability handling. Simulation of the body using a technique that treats the body as being deformable in a fashion that realistically approximates the deformation of a human body may also be used in areas other than joints. This use would allow garments that shape the body in some way to be modeled. For example, tight jeans may cause the buttocks and thighs to take on a more aesthetic shape.

Other garments may also hold or shape other soft parts of the body. By treating the body as deformable, these effects may be modeled.

At block 1110, the process starts. At block 1120, a deformation model is computed for a body. In one embodiment, the body is treated as deformable by using a finite element deformation model in place of the rigid-body model of the body. A deformation model based on finite differences, the boundary element method, modal analysis, or other method for computing deformations may be used in place of a finite element method. The deformation model (for the body) computes how skin, muscle, fat, and other components of the human body move, stretch, compress, and deform in response to external forces, such forces including gravity, contact forces from the clothing, weight from straps of a handbag or other accessories, contact with furniture, and other contacts between the body and other objects. The deformation model maybe also be data-driven so that it uses observations of real human bodies to determine how to compute body deformation. In one embodiment, this data is pre-calculated, and stored for each body model.

At block 1130, the garment size and fabric mechanical properties are retrieved.

At block 1140, a comparison between the garment data and the body model data determines whether deformation model is implicated. If the garment does not compress the user's body, because of the size and/or fabric, the deformation model does not need to be applied. The process then ends at block 1150.

If the system determines that the deformation model should be applied, the process continues to block 1160.

At block 1160, the system performs a deformed body simulation and cloth simulation in a two-way coupled way. The forces from the cloth simulation are conveyed to the body simulation, and vice versa. The level of compression of the body model, based on the calculated deformation model is balanced with the level of stretch of the garment model, based on the fabric mechanical characteristics. The result of this calculation determines a change in the body model shape as a result of compression due to the garment, and the change in the fabric mechanical characteristics and optionally fabric visual characteristics as a result of stretch due to the body model stretching the fabric.

At block 1170, the process determines whether the compression and/or stretch is beyond the capability of the fabric and/or body. That is, whether the garment compresses so far that it cannot fit the body model. If so, at block 1180, an error is indicated.

Otherwise, at block 1190, the model is stored. The process then ends at block 1150.

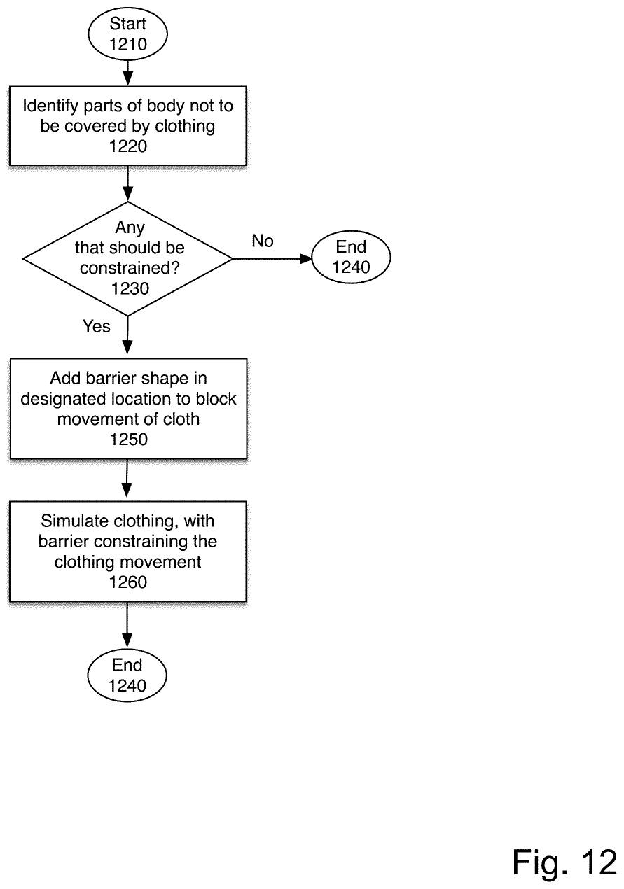

FIG. 12 is a flowchart of one embodiment of using barrier shape-based styling. Barrier based styling enables the styling of elements such as pushed up cuffs, pulled back collars. A human typically might prevent clothing from covering certain parts of his or her body. The process starts at block 1210. At block 1220, the system identifies parts of the body not to be covered by clothing. For example, people generally prefer that sleeves not cover their hands, and that collars not cover their face, etc.

At block 1230, the process determines whether any portion of the clothing item should be constrained. For example, for covering the hands, a sleeveless garment does not need any constraints. If no constraints are needed, the process ends at block 1240.

If a barrier is needed, at block 1250, one or more barrier shapes are added to the simulation that only block movement of the cloth, but not of the body. For example, a one-foot diameter sphere might be placed around each hand so that the sleeves will not be able to slide over the hands due to the sphere blocking such movement.

At block 1260, the clothing is simulated with the barrier constraining the movement of the cloth but not the body. Using the one-foot diameter sphere, for example, the sleeves will look as if the wearer pushed them back to expose the hands. This may also create stylish fabric bunching at the wrists. Other barrier shapes may be used as appropriate. In one embodiment, the barrier shapes may range from spheres, to cubes, cones, or other shapes. In some embodiments, the barrier may be a simple plane, prohibiting movement of the fabric beyond a particular plane.

In one embodiment, the barrier may be animated so that they move during the course of the simulation. In one embodiment, this feature may be useful for clothing elements that may have multiple configurations. This enables a user to see the clothing item in various configurations. For example, long sleeves that may be worn down or pushed up exposing the forearm, may be modeled with a barrier that starts initially positioned at the wrist and subsequently moves along the arm so that the cloth is pushed up, bunching in a realistic way, and exposes the forearm. In one embodiment, this animation showing the change in configuration may be made available to the user. In another embodiment, the user may choose a position for the sleeves (or other such moving item), and a still image may be used. The process ends at block 1240.

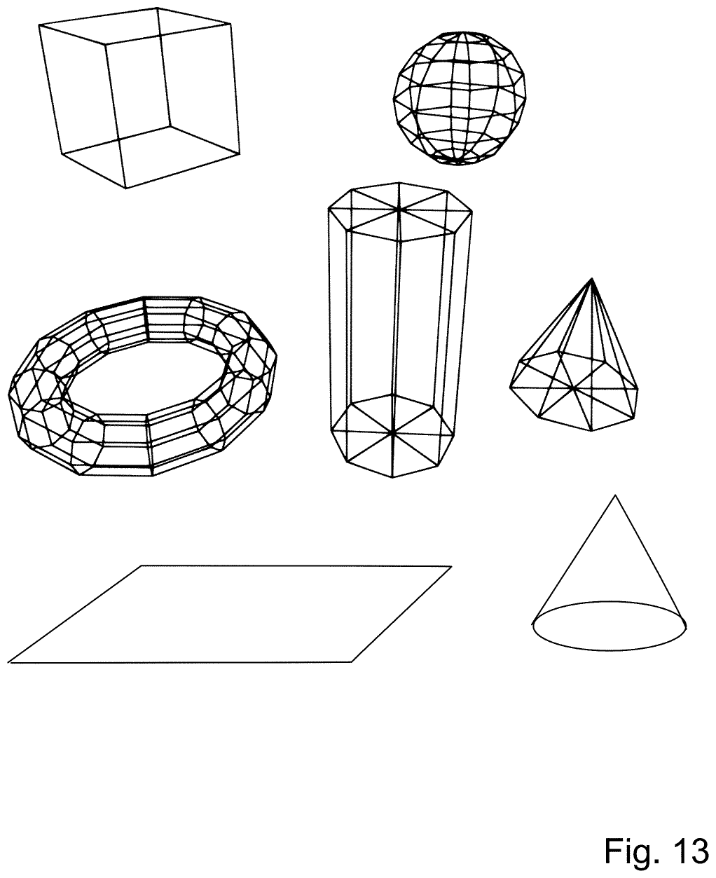

FIG. 13 illustrates exemplary barrier shapes that may be used.

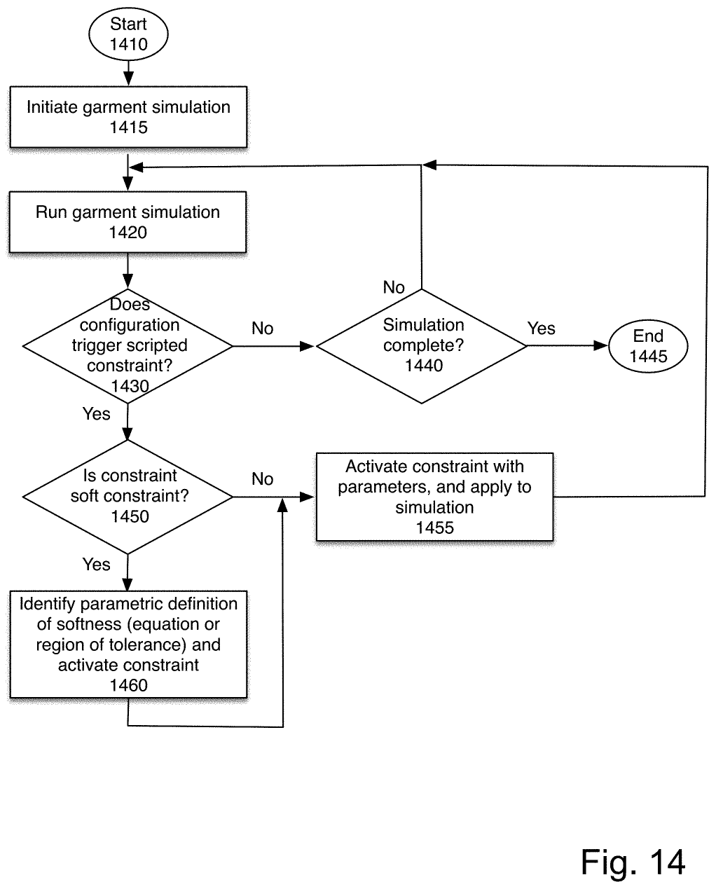

FIG. 14 is a flowchart of one embodiment of constraint adjustment based on soft constraints and scripting. The process starts at block 1410. At block 1415, the garment simulation is initiated. At block 1420, the garment simulation is run.

At block 1430, the process determines whether the configuration triggers a scripted constraint. Landmarks, guide points, symmetry enforcement, barriers, and other simulation constraints may be controlled by scripts that activate the constraints, move their locations, and/or vary their parameters as the simulation is running. The scripts may operate based on any of many factors, including the simulation time, based on the movement of the body hitting specified targets and/or configurations, and/or based on the movement of the cloth hitting certain targets. For example, symmetry might be enforced during most of a simulation, but then deactivated for the last ten percent of the time so as to allow a relaxed, sloppy look while still being mostly symmetric.

If no scripted constraints are triggered, at block 1440 the process determines whether the simulation is complete. If so, the process ends at block 1445. Otherwise, the process returns to block 1420, to continue running the simulation. Although this is illustrated as a loop it should be understood that the triggering of the script may be automatic when certain conditions are met while the simulation is running. There may be multiple scripts with different triggers and different effects.

If, at block 1430 a script is triggered, the process continues to block 1450. At block 1450, the process determines whether the constraint is a soft constraint or a hard constraint. Hard constraints can be used to attach a part of the cloth to a specified location on the body, or to another specified point on the cloth, such that the points are forced to always remain coincident. However, if the points should be allowed to move slightly with respect to each other, then hard constraints are not desirable. For example, if the open edge of a collar on an Oxford style shirt should stay in an upright position near the throat, then a constraint could be used to keep it positioned. A hard constraint would have no give to it, and it would create a configuration that causes pulling across the front of the shirt. A soft constraint would keep the collar approximately positioned without causing pulling. Soft versus hard constraints may apply to both the attachment of clothing to body and the relationship of symmetric elements to each other, as discussed above.

If the constraint is a hard constraint, at block 1455 the constraint is activated with parameters and applied to the element in the simulation. As noted, this means that the element is linked with the point of attachment, whether that is the body or another portion of the garment, as for symmetry. The process then returns to block 1420 to continue the simulation.

If the constraint identified is a soft constraint, at block 1460, the parametric definition of softness (the reaction of the constraint) is defined, and the constraint is activated. In one embodiment, a linear equation defines how the constraint reacts. The point is connected to a location (on the body or a symmetry point). A force is applied to push it back to that location when it moves. In one embodiment, the force is a linear or quadratic force, such that the distance-to-force relationship may be linear or quadratic. Other functions may also be used for the distance-to-force relationship, with different functions changing the visual appearance of the resulting output. In one embodiment, the element may have a region of tolerance, within which the force is kept at zero (or near zero). For example, a soft constraint on a lapel may permit it to move within a 1 mm region but shift it back toward laying flat on the jacket as it moves further away. The process then returns to block 1420, to continue the simulation.

In this way, the simulation can constrain certain elements within the simulation to behave in a predictable way, rather than fully simulating the element's potential movements.

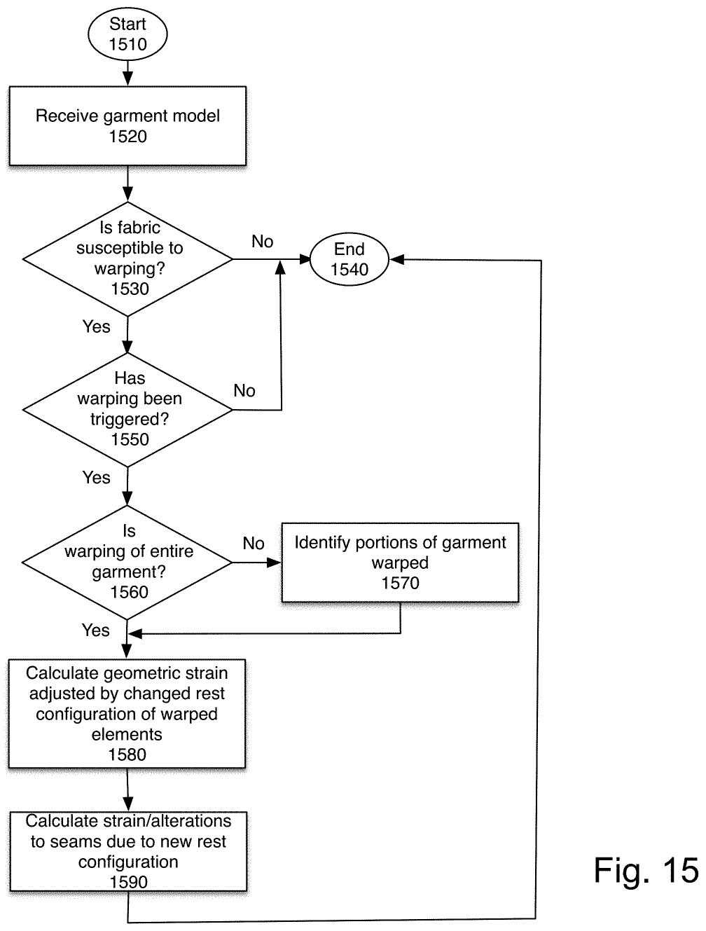

FIG. 15 is a flowchart of one embodiment of accounting for plastic warping of materials. The process starts at block 1510. At block 1520, the garment model is received. In one embodiment, the garment model is based on an unprocessed model (for example based on manufacturing information. Such a model does not account for shrinkage, or prewashed/pre-distressed materials. In order to be accurate, the fabric model should account for the prewashing, distressing, or other treatments that may not be fully characterized by the manufacturer's pattern. Therefore, in one embodiment, plastic warping is applied to the end garment model, to account for such changes. In one embodiment, this technique may also be applied to show changes in the garment over time, or due to the user washing the garment or applying distress treatments, or otherwise altering the garment.

At block 1530, the process determines whether the fabric is susceptible to warping. The term warping refers to processes that cause the material to contract, expand, possibly in an anisotropic fashion, or otherwise change its rest shape. Fabric in this context simply refers to the material which makes up the garment model, which may include materials such as leather, and elements such as buttons, as well as traditional fabrics. Some materials do not contract or expand. For example, certain leather, polyester, and other similar materials generally do not warp enough to be considered susceptible.

If the fabric is not susceptible, the process ends at block 1540.

Otherwise, at block 1550, the process determines whether warping has been triggered. In one embodiment, warping is triggered when the fabric contracts or expands. For example, if a pair of jeans will shrink during washing, either at the factory or in the consumers home, then warping would be triggered. This effect may be local, for example, if only part of a garment were shrunk by applied heat.

At block 1560, the process determines whether the warping is of the entire garment. If not, the portions of the garment which are warped are identified, at block 1570.

At block 1580, the geometric strain adjusted by the changed rest configuration of the warped elements is calculated. The simulation accounts for such changes using plastic warping. Plastic warping modifies the reference configuration of a simulated object using either multiplicative or additive offsets to the strain in the material. In one embodiment, the strain used to compute stress in the simulation is computed by taking the geometric strain and adjusting it to account for the shrunken or warped rest configuration. Alternatively, the process may adjust the shape and/or size of the panels to account for expansion/contraction. However, instances of non-uniform plastic change may result in rest configurations that are not embeddable in two or three dimensions. The method of plastic warping can handle such non-embeddable configurations.

At block 1590, the straining/alterations to the seams are calculated due to the new rest configuration. The process then ends at block 1540.

Of course, although many of these processes are shown in flowchart form, the ordering of the individual blocks may be altered, unless there is a direct dependency between blocks that would require a particular ordering. Furthermore, the elements illustrated as decision blocks may be interrupt driven, such that the action is automatically triggered when a condition is met, but not otherwise queried.

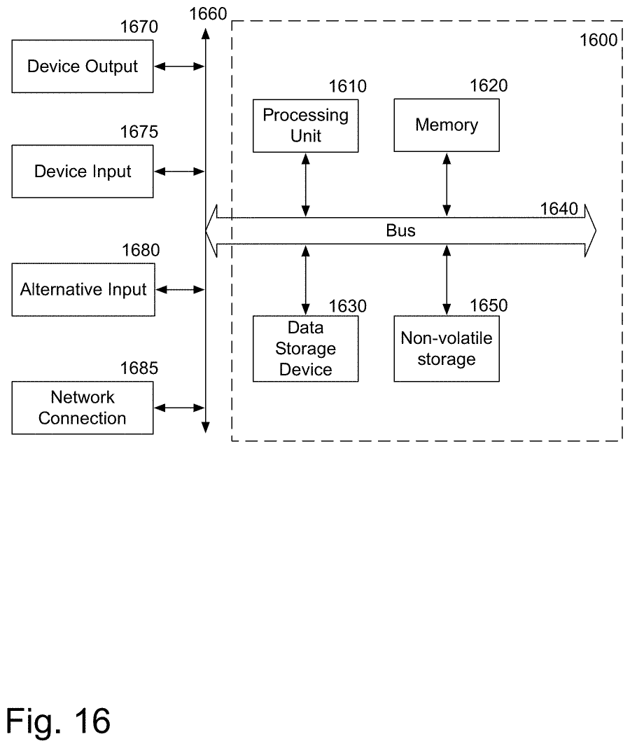

FIG. 16 is a block diagram of one embodiment of a computer system that may be used with the present invention. It will be apparent to those of ordinary skill in the art, however that other alternative systems of various system architectures may also be used.

The data processing system illustrated in FIG. 16 includes a bus or other internal communication means 1640 for communicating information, and a processing unit 1610 coupled to the bus 1640 for processing information. The processing unit 1610 may be a central processing unit (CPU), a digital signal processor (DSP), a graphics processing unit (GPU), or another type of processing unit 1610.

The system further includes, in one embodiment, a random access memory (RAM) or other volatile storage device 1620 (referred to as memory), coupled to bus 1640 for storing information and instructions to be executed by processor 1610. Main memory 1620 may also be used for storing temporary variables or other intermediate information during execution of instructions by processing unit 1610.

The system also comprises in one embodiment a read only memory (ROM) 1650 and/or static storage device 1650 coupled to bus 1640 for storing static information and instructions for processor 1610. In one embodiment, the system also includes a data storage device 1630 such as a magnetic disk or optical disk and its corresponding disk drive, or Flash memory or other storage which is capable of storing data when no power is supplied to the system. Data storage device 1630 in one embodiment is coupled to bus 1640 for storing information and instructions.

The system may further be coupled to an output device 1670, such as a cathode ray tube (CRT) or a liquid crystal display (LCD) coupled to bus 1640 through bus 1660 for outputting information. The output device 1670 may be a visual output device, an audio output device, and/or tactile output device (e.g. vibrations, etc.) Output may also be stored on a storage device for display or use at a later time.

An input device 1675 may be coupled to the bus 1660. The input device 1675 may be an alphanumeric input device, such as a keyboard including alphanumeric and other keys, for enabling a user to communicate information and command selections to processing unit 1610. An additional user input device 1680 may further be included. One such user input device 1680 is cursor control device 1680, such as a mouse, a trackball, stylus, cursor direction keys, or touch screen, may be coupled to bus 1640 through bus 1660 for communicating direction information and command selections to processing unit 1610, and for controlling movement on display device 1670.

Another device, which may optionally be coupled to computer system 1600, is a network device 1685 for accessing other nodes of a distributed system via a network. The communication device 1685 may include any of a number of commercially available networking peripheral devices such as those used for coupling to an Ethernet, Internet, or wide area network, personal area network, wireless network, or other method of accessing other devices. The communication device 1685 may further be a null-modem connection, or any other mechanism that provides connectivity between the computer system 1600 and other devices.

Note that any or all of the components of this system illustrated in FIG. 16 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1620, mass storage device 1630, or other storage medium locally or remotely accessible to processor 1610.

It will be apparent to those of ordinary skill in the art that the system, method, and process described herein can be implemented as software stored in main memory 1620 or read only memory 1650 and executed by processor 1610. This control logic or software may also be resident on an article of manufacture comprising a computer readable medium having computer readable program code embodied therein and being readable by the mass storage device 1630 and for causing the processor 1610 to operate in accordance with the methods and teachings herein.

The present invention may also be embodied in a handheld or portable device containing a subset of the computer hardware components described above. For example, the handheld device may be configured to contain only the bus 1640, the processor 1610, and memory 1650 and/or 1620.

The handheld device may be configured to include a set of buttons or input signaling components with which a user may select from a set of available options. These could be considered input device #1 1675 or input device #2 1680. The handheld device may also be configured to include an output device 1670 such as a liquid crystal display (LCD) or other display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 1610, a data storage device 1630, a bus 1640, and memory 1620, and no input/output mechanisms, or only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 1685.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1610. A machine-readable medium includes any mechanism for storing information in a form readable by a machine (e.g. a computer). For example, a machine-readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A method of transforming a garment into a garment model and rendering a depiction of the garment, comprising:
generating a body shape, the body model representing an approximation of the user's shape for presenting a garment model, the body shape including a plurality of landmarks, the landmarks defining locations with which guide points on the garment model are associated;
creating a garment model for simulation, the garment model including at least one guide point; and
generating a depiction of the garment model on a body shape, wherein the garment model is positioned based on at least one landmark and an associated guide point.

2. The method of claim 1, further comprising:
removing identifying characteristics from the body model to create a neutral body model.

3. The method of claim 1, further comprising:
utilizing statistical data to complete missing measurements from the body model.

4. The method of claim 3, wherein statistical data is adjusted based on a known target demographic.

5. The method of claim 1, further comprising:
animating the body model enable the creation of modeling stances, the animation utilizing a rig skeleton.

6. The method of claim 5, wherein the animating utilizes semantic constraints.

7. The method of claim 1, further comprising:
addressing pinching between body parts of the body model by one or more of: modifying the shape of a body part, altering a pose, and reducing a compliance of the body part.

8. The method of claim 1, further comprising:
addressing fabric warping by calculating a geometric strain on the fabric adjusted by a changed rest configuration of warped elements of a garment.

9. The method of claim 1, further comprising:
defining a macro, the macro representing a complex garment element having a plurality of consistent characteristics; and
utilizing the macro by applying the macro to a garment.

10. The method of claim 1, further comprising:
utilizing STN vectors to define an embellishment on the garment, the embellishment attached to the garment.

11. The method of claim 1, further comprising:
creating a point association between two points of a garment across a line or plane of symmetry, wherein the association forces the two points to remain in symmetry.

12. The method of claim 1, further comprising:
using a barrier to define an area that the garment cannot enter, the barrier used to constrain movement of the garment.

13. The method of claim 12, wherein the barrier is associated with a part of the body shape and moves with the body shape.

14. The method of claim 1, further comprising:
applying a soft constraint on a design, wherein the soft constraint is on one or more of: a point association to force approximate symmetry, a barrier to constrain movement, landmarks, and guide points;
wherein the soft constraint allows some flexibility in element relationships based on a stiffness of the soft constraint.

15. The method of claim 1, further comprising:
Applying a hard constraint on a design, wherein the hard constraint is where the hard constraint attaches the cloth to a specified location, on the body shape or on the cloth, to force the points to remain coincident.

16. The method of claim 1, further comprising:
Up-sampling a portion of a garment to represent a more detailed garment geometry without distortion.

17. The method of claim 16, where up sampling is accomplished with physics-based optimization.

18. The method of claim 1, further comprising:
down-sampling of a garment to represent the garment using less data, to reduce memory use and/or reduce computation.

19. The method of claim 18, where down sampling is accomplished with physics-based optimization.

20. The method of claim 1, further comprising:
creating a deformation model for the body shape, the deformation model using a finite element deformation model of the body shape in which a garment can compress a portion of the body shape.

21. The method of claim 19, further comprising:
performing a coupled body model simulation and cloth simulation, on the deformation model, utilizing the deformation model for the body shape and fabric mechanical characteristics, to determine a change in a body model shape as a result of compression due to the garment, and a change in the fabric mechanical characteristics and fabric visual characteristics as a result of stretch due to the body model.
